(19) United States
(12) Patent Application Publication
(10) Pub. No.: US 2020/0337815 A1
(43) Pub. Date: Oct. 29, 2020

(54) SOFT INTERDENTAL BRUSHES RECEPTACLE FRAME AND METHODS FOR MANUFACTURING SOFTINTERDENTAL BRUSHES USING SAME

(71) Applicant: Jian Zhu, Westport, CT (US)

(72) Inventor: Jian Zhu, Westport, CT (US)

(21) Appl. No.: 16/397,184

(22) Filed: Apr. 29, 2019

(51) Int. Cl. A61C 15/00

(52) U.S. Cl. CPC A61C 15/00; A46B 2200/108

(57) ABSTRACT

Method of making soft interdental brushes, which relates to the field of daily necessities and solves the problems of unsightly fracture points and causing skin scratches at the fracture points with the current producing process. The method includes forming a receptacle frame with technical points as follows: a receptacle plate for organizing the brushes and receiving columns for fixing the brushes, the receptacle plate and the receptacle columns are fixedly attached; The method also adopts an interference fit approach to collect the brushes through the receptacle frame, meanwhile, the material after the injection will be cut off once the brushes are received by the receptacle frame. Compared with the traditional technology, the utility model makes the soft interdental brush more convenient to pick off, furthermore, there will be no residual connecting strips on the brush, so that the brush will not cut the skin while be more artistic.

### BACKGROUND

The present invention relates generally to a soft interdental brushes receptacle frame and methods for manufacturing soft interdental brushes using it.

The soft interdental brush, similar to the ordinary toothbrush, can be divided into two parts: the brush head and the brush handle. The biggest difference lies in the design of the brush head. The brush head of the soft interdental brush is conical, with different sizes. It is suitable for the seam of teeth with different widths. The brush head of different specifications can be selected to clean the seam and the tooth surface based on the needs. It can remove the plaque in the seam and keep teeth clean.

At present, the soft interdental brushes on the market are produced with handles connected in a row, which makes the soft interdental brushes arranged neatly. However, because the soft interdental brushes are connected with each other in a row, when using the soft interdental brushes, they need to be twisted off or cut off. There are still connecting strips on the brush handles after twisting. The remaining connecting strips may cut the skin when using, also may make the soft interdental brushes look sloppy.

### SUMMARY

The object of the present invention is to provide a method for manufacturing soft interdental brushes that includes forming a receptacle plate with columns and opening matching holes on the brush handles to fix the interdental brushes to the plate on the columns, which will solve the problem of untidy look at fraction points and possible skin cut with current producing method.

To achieve the above purpose, the present invention provides the following technical scheme:

The soft interdental brush receiving frame, which comprises a receiving plate for organize the brushes and receiving columns for fixing the brushes, the receiving plate and the receiving columns are fixedly connected.

As a further scheme of the present invention, the receiving column is cylindrical or rhombic.

As a further scheme of the present invention, the receiving columns are formed with a chamfer on each column to make it easier to install the brushes.

The soft interdental brushes for matching use of the brush receptacle frame comprises a main body of the interdental brush and a receptacle hole that is arranged on the brush handle.

As a further scheme of the present invention, the shape of the receiving hole is the same as the cross-section shape of the receiving column.

In summary, the present invention has the following beneficial effects compared with the existing technology.

The present invention adopts an interference fit method to collect the soft interdental brushes through the receptacle frame and cut off the material after the injection of the soft interdental brush. Compared with the existing technology, the present invention makes the soft interdental brush more convenient to pick off, furthermore, there will be no residual connecting strips on the brush handles, so that the skin fraction will be avoided and the brush will look tidy.

### BRIEF DESCRIPTION OF THE DRAWINGS

FIG. 1 is a schematic diagram of the soft interdental brush receptacle frame.

FIG. 2 shows the structure of the soft interdental brush.

FIG. 3 is a schematic diagram of the structure of the soft interdental brush receptacle frame and the matching soft interdental brushes.

FIG. 4 shows the structure of the soft interdental brush after injection.

Reference Items: 1-Receiving Plate, 2-Receiving Column, 3-Soft interdental Brush Body, 4-Receiving Hole, 5-Bar

### DETAILED DESCRIPTION

In the following, the embodiments of the present invention will be described clearly and completely below with reference to the drawings. It is to be understood that the invention is not limited in its application to the details of construction and the arrangements of the components set forth in the following description or embodiments, or illustrated in the drawings. The invention is capable of other embodiments and of being practiced or being carried out in various ways. Also, it is to be understood that the phraseology and terminology used herein is for the purpose of description and should not be regarded as limiting.

### Example 1

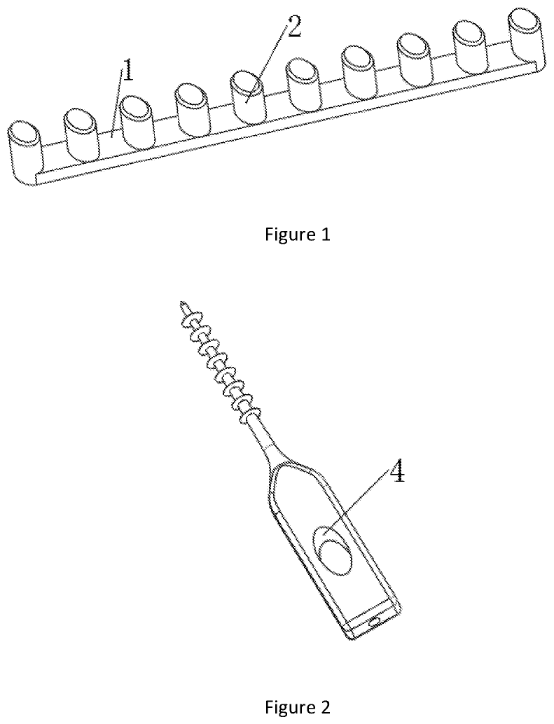

As shown in FIG. 1, a soft interdental brush receptacle frame comprises a receptacle plate 1 and receptacle columns 2, the receptacle columns 2 are fixedly positioned on receptacle 1.

The receptacle plate 1 is in a strip shape, the receptacle column 2 is an elliptical cylinder, there are 10 receptacle columns uniformly distributed on the receptacle plate 1. The function of the receiving column 2 is to fix the main body 3 of the soft interdental brush.

Preferably, the receiving column 2 is formed with a chamfer which makes it easier to install the soft interdental brush.

As shown in FIG. 2, a soft interdental brush comprises a main brush body 3, and a receptacle hole 4, which is arranged on the brush handle of the main brush body 3. The shape of the receptacle hole 4 matched to the shape of the receptacle column 2.

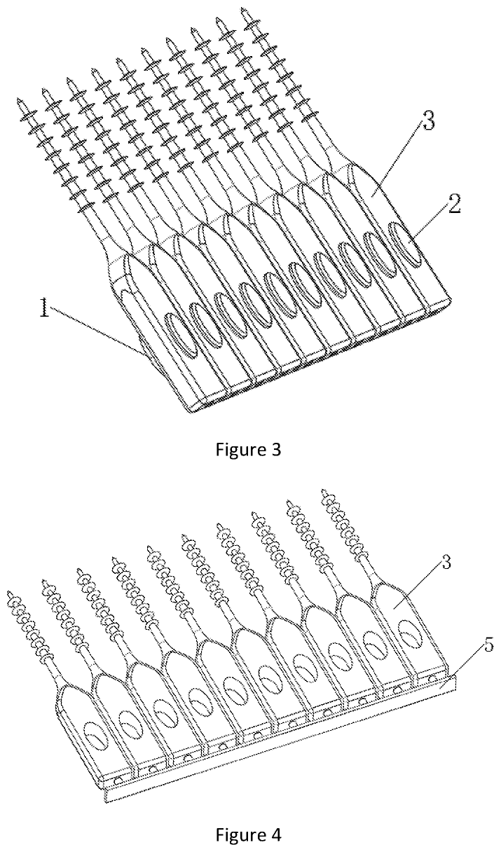

As shown in FIG. 3, the way of matching the soft interdental brush receptacle frame and the soft interdental brush is that the receptacle hole 4 on the main body 3 of the soft interdental brush is connected to the receptacle column 2 through interference fit, and when being used, the main body 3 of the soft interdental brush can be pulled out from the receptacle column 2.

In the manufacturing method, the rack of injection molded soft interdental brushes shown in FIG. 4 with bottom connected to bar 5 is mounted on the receiving columns 2. Each column 2 fits within one receiving hole 4, and then bar 5 will be cut off, after which the injection molded soft interdental brush will be divided into individual soft interdental brushes. This cutting process will remove the redundant material on each soft interdental brush and make it look neat.

### Example 2

As shown in FIG. 1, a soft interdental brush receptacle frame comprises a receptacle plate 1 and receptacle columns 2, the receptacle plate 1 and receptacle columns 2 are fixedly connected.

The receptacle plate 1 is in a strip shape, the receptacle column 2 is a diamond shaped cylinder, there are 10 receptacle columns uniformly distributed on the receptacle plate 1. The function of the receiving column 2 is to fix the main body 3 of the soft interdental brush.

Preferably, the receiving column 2 is formed with a chamfer which makes it easier to install the soft interdental brush.

As shown in FIG. 2, a soft interdental brush comprises a main brush body 3, and a receptacle hole 4, which is arranged on the brush handle of the main brush body 3. The shape of the receptacle hole 4 matched to the shape of the receptacle column 2.

As shown in FIG. 3, the way of matching the soft interdental brush receptacle frame and the soft interdental brush is that the receptacle hole 4 on the main body 3 of the soft interdental brush is connected to the receptacle column 2 through interference fit, and when being used, the main body 3 of the soft interdental brush can be pulled out from the receptacle column 2.

In the manufacturing method, the rack of injection molded soft interdental brushes shown in FIG. 4 with bottom connected to the bar 5 is mounted on the receiving columns 2. Each column 2 fits within one receiving hole 4, and then the bar 5 will be cut off, after which the injection molded soft interdental brush will be divided into individual soft interdental brushes. This cutting process will remove the redundant material on each soft interdental brush and make it look neat.

In summary, the principle of the present invention is as follows:

In the process of making the soft interdental brush body 3, receptacle hole 4 is also produced, and then receptacle plate 1 with receptacle column 2 having the same shape as receptacle hole 4 is processed. Through interference fit, receptacle column 2 with matching receptacle hole 4 makes the soft interdental brush body 3 more neat and easier to pick off. At the same time, the bar 5 on soft interdental brush body 3 is removed. Comparing with the traditional manual removal of each soft interdental brush, the operation and removal process in the present invention make the soft interdental brushes more uniform and safer to use.

In particular, the shape of the soft interdental brush in present invention is the application of the existing technology. Opening receptacle holes on the soft interdental brush body 3 and using receptacle frame to organize the soft interdental brushes are the innovation, which effectively solves the problems such as the unsightly breaking point and the scratching of the skin at the breaking point.

Although the embodiments of the present invention have been shown and described, it is understandable for ordinary technicians in the field that various changes, modifications, substitutions and modifications can be made to these embodiments without departing from the principle and spirit of the present invention. The scope of the present invention is limited by the appended claims and their equivalents.

1. A method for manufacturing soft interdental brushes, the method comprising: forming a receiving frame including a receiving plate (1) for organizing the brushes, receiving columns (2) for fixing the brushes, the receiving columns (2) are fixedly attached to the receiving plate (1).

2. The method of claim 1, wherein forming the receiving columns (2) in shape of cylinder or diamond.

3. The method of claim 1, wherein forming the receiving columns (2) with a chamfer on each column to make it easier to install the brushes.

4. A method for manufacturing soft interdental brushes, the method comprising: forming the soft interdental brushes to match the use of the brush receiving frame in claim 1-3, each interdental brush contains an interdental brush body (3) and a receptacle hole (4) arranged on the brush handle of the brush body (3).

5. A method of claim 4, wherein forming the soft interdental brushes with holes in the matching shape of the receiving columns (2).
